(19) United States
(12) Patent Application Publication
(10) Pub. No.: US 2026/0163517 A1
(43) Pub. Date: Jun. 11, 2026

(54) METHODS AND SYSTEMS FOR REGENERATIVE BRAKING OF SOLAR TRACKERS

(71) Applicant: Nextpower LLC, Fremont, CA (US)

(72) Inventors: Alessio Orsini, Menlo Park, CA (US); Alexander W. AU, Oakland, CA (US); Riming Shao, Fremont, CA (US)

(21) Appl. No.: 19/407,377

(22) Filed: Dec. 3, 2025

Related U.S. Application Data
(60) Provisional application No. 63/729,715, filed on Dec. 9, 2024.

(51) Int. Cl. H02S 20/32; F24S 30/00; F24S 30/425

(52) U.S. Cl. CPC H02S 20/32; F24S 30/425; F24S 2030/134; F24S 2030/19

(57) ABSTRACT

Systems and methods for operating a solar tracker row of a solar array to generate electrical energy via regenerative braking. Systems and methods may include allowing an electric motor to be back-driven by an external mechanical force (such as wind), generating electrical energy and/or providing a braking force from back-driving the electric motor, and charging an energy storage device with the generated electrical energy.

### RELATED MATTERS

This application claims the benefit of U.S. Provisional Patent Application No. 63/729,715, filed Dec. 9, 2024. The entire contents of each of these applications are incorporated herein by reference.

### TECHNICAL FIELD

This disclosure relates generally to solar tracker systems, and more particularly to systems and methods for regenerative braking of solar tracker rows during windy conditions.

### BACKGROUND

Solar cells and solar panels are most efficient in sunny conditions when oriented towards the sun at a certain angle. Many solar panel systems are designed in combination with solar trackers, which enable the solar panels or solar modules to follow the sun's trajectory across the sky from east to west to maximize the electrical generation capabilities of the systems. Typically, a relatively large number of solar cells are arranged in an array to generate energy in sufficient amounts to be usable, for example as part of an energy grid. As a result, solar trackers have been developed that are quite large, spanning hundreds of feet in length and including hundreds of individual solar modules that are mechanically coupled to support structures.

Adjusting the positions of solar trackers in an array requires power to drive the solar trackers of the solar array as they follow the sun. As will be appreciated, the greater the load, the greater the amount of power necessary to drive the solar tracker. Such power is typically provided via a drive assembly, which can include a motor and a gear assembly or gear box.

Wind loading (or other similar forces, such as snow) can exert significant force upon the structure for supporting and the mechanisms for articulating the solar tracker. For example, when the external force (e.g., wind) is sufficiently strong (e.g., in excess of 20 m.p.h., for example), it may become desirable to move the solar trackers to a stow position that is less likely to result in damage to the solar trackers and/or the solar modules from the strong winds. This is typically accomplished by driving the solar modules to a stow position where the loads created by the wind are reduced. In some circumstances, the wind loading force may be sufficient to overcome frictional forces and other forces that resist movement of a given solar tracker row, and the solar tracker row begins to move (e.g., rotate, or change angular orientation) in response to the wind loading force. Such motion of the solar tracker row may begin to turn the associated motor (e.g., via the efficient gear drive) in a manner that may result in the generation of electricity and an associated braking force. As can be appreciated, this response may be somewhat contrary to the original intent of the motor of the solar tracker row. The present disclosure seeks to address the shortcomings of prior solar tracker systems.

### SUMMARY

One aspect of this disclosure is directed to a method of operating an array of solar trackers or a plurality of solar tracker rows. Each row of solar trackers in the array may include a number of bearings, a number of piers, each pier supporting a bearing, and a torque tube received in the plurality of bearings and configured to support a plurality of solar modules. Each solar tracker row has a drive motor, and each drive motor has an efficient (e.g., a “high efficiency”) gear box associated with it.

In some embodiments, the high efficiency drive replaces the worm gear used in the slew drive (of prior or traditional systems) with a planetary gear arrangement. The planetary gear arrangement has a higher efficiency and requires less energy to drive the solar tracker row, but it can also be back driven more easily. In some implementations, the back holding of the new drive is enough to not be moved by a small gust of wind, for example, but when a wind gust strong enough (e.g., greater than about 20 mph, 25 mph, 30 mph, 35 mph, or greater wind speeds, for example) hits the solar tracker row, the drive would likely move (e.g., be back-driven), which would back-drive the motor. Back-driving of the motor may result in the motor functioning as an electrical generator; that is, allowing the motor to be back-driven by the force of the wind would result in the motor generating electrical energy (e.g., voltage and current), which could be stored in an energy storage device (e.g., a battery, or a capacitive energy storage device, etc.) for later use. Additionally, back-driving of the motor that results in generation of electrical energy may provide a braking force that helps to slow the speed at which back-driving of the motor occurs. This braking force may also function to help avoid overvoltage or overcurrent faults in the associated solar tracker controllers, for example.

In some embodiments, a motor of a solar tracker row may be allowed to be back-driven by the force of winds to thereby generate electrical energy and provide a braking force as the solar tracker row is moved to a stow position. In some implementations, a desired stow position may be selected to more fully utilize or maximize the ability of the motor to act as an electrical generator in certain circumstances. For example, in a case where two possible stow positions are available, it may be preferable to select the stow position that involves allowing the motor of the solar tracker row to be back-driven, or to be back-driven a greater amount, for example.

In some embodiments of this disclosure, a solar tracker system for a solar array is described. The solar tracking system is configured to generate electrical power using a plurality of solar tracker rows, with each solar tracker row including a plurality of support piers, a torque tube extending along the solar tracker row rotatably supported on the plurality of support piers, a plurality of solar modules coupled to the torque tube, and a motor configured to cause the torque tube to rotate via an efficient gear drive, the motor and the efficient gear drive configured to be back driven by a strong wind force. In some embodiments, back-driving of the motor generates electrical energy, which can be used or stored for later use. In some embodiments, back-driving of the motor functions as a regenerative brake to resist the strong wind force.

In some embodiments of this disclosure, a method of operating a solar array to generate electrical power and provide a regenerative braking force is described. The method of operating a solar array to generate electrical power may include a number of steps, including: identifying a plurality of rows of rotatable solar trackers that form the solar array, each of the rows of rotatable solar trackers comprising a plurality of solar panel modules, and each of the rows of rotatable solar trackers configured to be rotated about an axis via an efficient drive mechanism comprising an electric motor and an efficient gear box; exposing the solar tracker to an external mechanical force (such as a wind force); allowing the solar tracker row to be rotated about the axis by the external mechanical force such that rotation of the solar tracker row about the axis causes the electric motor to be back-driven via the efficient gear box; generating electrical energy and a braking force from back-driving the electric motor; and charging an energy storage device with the generated electrical energy.

Other embodiments include corresponding computer systems, apparatuses, and/or computer programs recorded on one or more computer-readable storage devices, each configured to perform the actions of the methods and systems described herein.

Implementations of various aspects of this disclosure may include one or more of the following features. A solar tracker where a plurality of brakes are comprised of mechanical brakes. The plurality of brakes is achieved by shorting windings of the motor. A resistance across the windings is adjusted to control the braking force. The solar tracker may further include a plurality of linear actuators. The linear actuators may include a lead screw in mechanical communication with the high efficiency gear box, a nut configured to receive the lead screw and a sleeve, where the lead screw is driven into and out of the nut to rotate the torque tube and the solar modules. Each distributed motor controller is embodied in or located in the proximity of an individual one of the plurality of drive motors. The solar tracker further including a master controller in communication with the distributed motor controllers. The master controller and the distributed motor controllers are in communication to apply or terminate application of energy to the plurality of motors and plurality of brakes in a coordinated manner. The solar tracker further including a plurality of sensors, the plurality of sensors providing feedback data to the distributed motor controllers and the master controller regarding energy usage of the plurality of motors and plurality of brakes or position of the solar tracker. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

A further aspect of this disclosure is directed to a solar tracker including a plurality of piers, one end of the piers configured for installation in the earth; a plurality of bearings, each bearing supported by a pier. The tracker also includes a torque tube received in the plurality of bearings and configured to support a plurality of solar modules; at least one drive motor associated with a pier; a high efficiency gear box associated with one of the at least one drive motor; and a motor controller, the motor controller including a memory storing therein instructions which when executed by a processor cause the motor controller to perform steps of: receive wind speed and wind direction data from a sensor; determine that the wind speed exceeds a threshold; determine an orientation of the solar tracker; determine a direction for rotation of the solar tracker to a nearest appropriate stow position; and allow the solar tracker to be driven to the appropriate stow position, or drive the solar tracker into the wind to the appropriate stow position. Other embodiments of this aspect include corresponding computer systems, apparatus, and computer programs recorded on one or more computer storage devices, each configured to perform the actions of the methods and systems described herein.

Implementations of this aspect of this disclosure may include one or more of the following features. The solar tracker where the instructions stored on the memory and executed by the processor cause the motor controller to perform a step of: determine whether the wind direction loads the solar tracker. The instructions stored on the memory and executed by the processor cause the motor controller to perform a step of: determine a position of the solar tracker in a solar power plant. The nearest appropriate stow position is determined based on the wind speed, wind direction, and location of the solar tracker in the solar power plant. The nearest appropriate stow positions requires the back driving of the solar tracker into the direction of the wind. The instructions stored on the memory and executed by the processor cause the motor controller to perform a step of: determine that the wind speed does not exceed a threshold; and determine whether the solar tracker is in a stow position. The instructions stored on the memory and executed by the processor cause the motor controller to perform a step of: determine whether diffuse light conditions are detected, where if no diffuse light conditions are detected the motor controller drives the solar tracker to a sun tracking position. The instructions stored on the memory and executed by the processor cause the motor controller to perform a step of: determine whether diffuse light conditions are detected, where if diffuse light conditions are detected the motor controller drives the solar tracker to a diffuse light position. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Still a further aspect of this disclosure is directed to a high efficiency gear box and drive assembly for a solar tracker. The high efficiency gear box includes an electric motor. The box also includes a gear box mechanically coupled to the electric motor, where the gear box is configured to permit back driving of the solar tracker; a motor controller in electrical communication with the electric motor, where the motor controller includes a memory storing therein instructions when executed by a processor cause the motor controller to perform steps of: receive wind speed and wind direction data from a sensor; determine that the wind speed exceeds a threshold; determine an orientation of the solar tracker; determine a direction for rotation of the solar tracker to a nearest appropriate stow position; and allow the solar tracker to be driven to the appropriate stow position. Other embodiments of this aspect include corresponding computer systems, apparatus, and computer programs recorded on one or more computer storage devices, each configured to perform the actions of the methods and systems described herein.

Implementations of this aspect of this disclosure may include one or more of the following features. The high efficiency gear box and drive assembly further including a mechanical brake. To enable and/or control back driving of the solar tracker, the motor controller may reduce the amount of current or voltage applied to the motor such that loading of the solar tracker caused by external forces (e.g., wind, snow, animals, vegetation) is sufficient to overcome the force of the motor, and the amount of back drive is thereby controlled by the electric motor. The determination of a direction of rotation (e.g., towards an appropriate stow position) is based on the wind speed, wind direction, orientation of the solar tracker, and position of the solar tracker within a solar power plant. The instructions when executed by a processor cause the motor controller to perform steps of returning the solar tracker to a sun tracking position upon determining that the wind speed is below a threshold. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Implementations of this aspect of this disclosure may include one or more of the following features. The solar tracker where the plurality of brakes are mechanical brakes. The plurality of brakes is achieved by shorting windings of the motor. A resistance across the windings is adjusted to control a braking force. The plurality of high efficiency gear box includes one or more planetary, helical, spur gears, bevel gears, face gears, spiral bevel gears. The plurality of high efficiency gear boxes has an efficiency of approximately 90%. The plurality of high efficiency gear boxes includes two sets of planetary gears. Implementations of the described techniques may include hardware, a method or process, or computer software on a computer-accessible medium, including software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In some embodiments, a high efficiency gear box may include a planetary gear arrangement. The use of a high efficiency gear box results in significantly less energy being required to drive the solar trackers rows to a different position relative to a solar energy source (e.g., to follow the sun to improve solar energy production, or to place in a stow position to protect from damage, etc.). However, the use of higher efficiency gearing also results in the solar tracker row being more easily back-driven by external forces (such as wind, snow, etc.). That is, the high-efficiency gearing may enable a sufficient external force (e.g., a strong wind) to move a solar tracker row against the resistance of the gearing and/or motor force. In some embodiments, rather than treat the back-driving of a solar tracker row as a problem to be avoided (e.g., by using lower efficiency gear boxes, worm drives, etc., to resist or prevent back-driving of the solar tracker rows and associated motors), the back-driving of the motor via a high efficiency gear box may be used to advantage according to various embodiments of this disclosure. For example, back-driving of the motor may be employed as a trigger, or as a way to generate a trigger signal, to initiate movement of a solar tracker row to a stow position. In some embodiments, the back-driving of the motor of a given solar tracker row may be employed to selectively trigger the stowing of only those solar tracker rows experiencing external forces (e.g., wind force, snow force, animals, vegetation, etc.) that meet or exceed a predetermined threshold; in such embodiments, other relatively “unaffected” solar tracker rows could be allowed to remain in their operable positions (e.g., oriented in a tracking position relative to the sun to continue generating as much electrical energy as practicable) and continue operating until conditions warrant moving them to a stow position on a per row basis. When the wind force on a solar tracker row that was moved to a stow position (due to high wind force) is reduced below a certain threshold, the particular solar tracker row could be returned to normal operation and driven to its normal tracking position, for example. In some implementations, the threshold force for returning a row to normal operation may be different (e.g., lower) than the threshold force for placing the row in a stow position to effectuate a form of “hysteresis,” which may help avoid making excessive movements of solar tracker rows to and from the stow position, for example. The selective stowing of solar tracker rows in the manner described herein may help achieve higher levels of overall solar energy production, while avoiding damage to solar tracker rows that are exposed to higher external forces.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of this disclosure. The drawings are intended for use in conjunction with the explanations in the following description. Embodiments of this disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a lower perspective view of a portion of a solar tracking system configured to articulate the angle of a solar array to track the location of the sun;

FIGS. 2A and 2B are schematic, top perspective views of solar tracker rows;

FIG. 3 is a schematic, top perspective view of a number of solar tracker rows in accordance with this disclosure;

FIG. 4 is a schematic side view of a solar tracker in accordance with this disclosure;

FIG. 5 is a cross-sectional side view and an end view of a gear assembly in accordance with this disclosure;

FIG. 6 is a flow diagram of a method of operating a solar array in accordance with some embodiments of this disclosure;

FIG. 7 is a flow diagram of a method of operating a solar array in accordance with some embodiments of this disclosure;

FIG. 8A is a perspective view of a linear drive and solar tracker bearing assembly mounted on a pier in a first position in accordance with this disclosure;

FIG. 8B is a perspective view of a linear drive and solar tracker bearing assembly mounted on a pier in a second position in accordance with this disclosure; and

FIG. 9 is a schematic view of a solar tracker control system in accordance with this disclosure; and

FIG. 10 is a schematic block diagram of a solar tracking system illustrating exemplary components for employing regenerative braking in accordance with this disclosure.

### DETAILED DESCRIPTION

This disclosure relates generally to solar tracker systems. More particularly, this disclosure relates generally to systems and methods for generating electrical energy and/or providing a braking force during certain conditions involving an external mechanical force (e.g., high wind, snowstorms, etc.) by allowing an electrical motor to be back-driven by the external mechanical force. In some examples, allowing the electrical motor to be back-driven by the external mechanical force may result in generating electrical energy and/or providing a braking force. In some embodiments, the electrical energy generated by the back-driven motor may be used to charge an energy storage device with the generated electrical energy. In some implementations, electrical energy is generated while the electrical motor is being back-driven to a “stow” position. Stowing can be defined as causing a solar tracker, or a solar tracker row, or a plurality of solar trackers (e.g., a solar array), to rotate to a desired angle, such that an upper portion or top surface of the solar modules face at a desired angle. In some examples, the desired angle can be referred to as a stow angle, and a solar tracker row that has been rotated to the stow angle may be said to be in a stow position. The selection of the stow angle can depend on, or may be affected by, a number of factors; however, in some examples, the stow angle is between −90 degrees and +90 degrees relative to horizontal. In some examples, the stow angle is −75 degrees or +75 degrees relative to horizontal. In some examples, the stow angle is −60 degrees or +60 degrees relative to horizontal. In some examples, the stow angle is −50 degrees or +50 degrees. In some examples where hail, for example, is not a concern, the stow angle may be selected to be 0 degrees (e.g., parallel) to the horizontal.

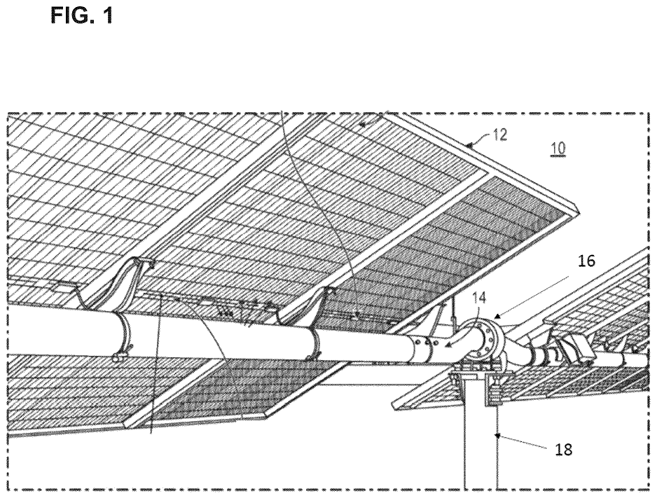

Referring now to the drawings, FIG. 1 illustrates a perspective view of a relatively common arrangement for a solar tracker 10. FIG. 1 shows an exemplary solar tracker 10 including a torque tube 14 rotatably supported by a number of piers 18 via a drive mechanism 16 supported by one of the piers 18. The torque tube 14 supports a number of solar modules 12 coupled to the torque tube 14; the torque tube 14 is configured to rotate about a generally longitudinal axis to follow or track the position of the sun as it moves throughout the day.

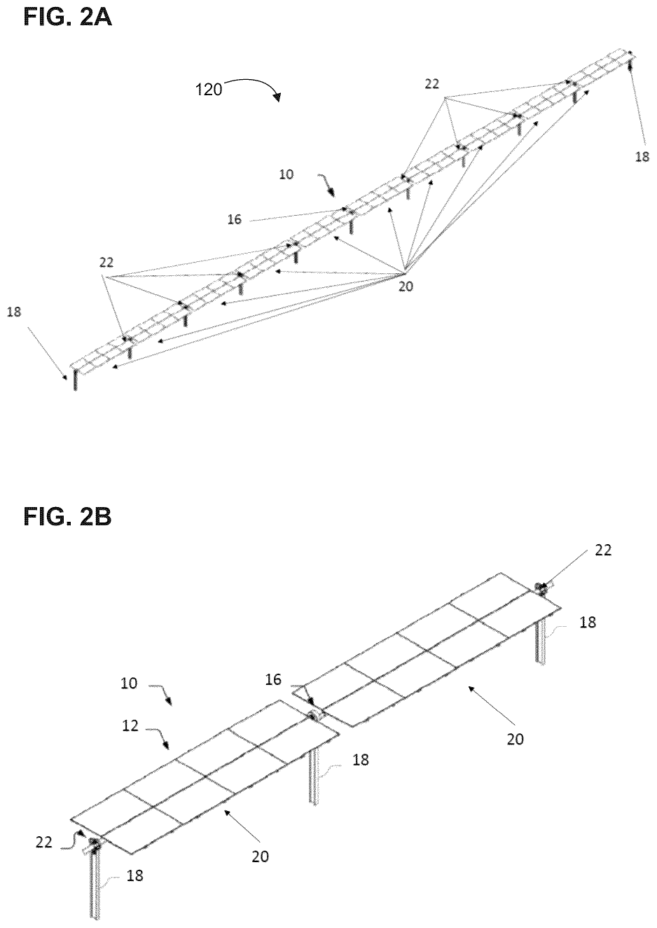

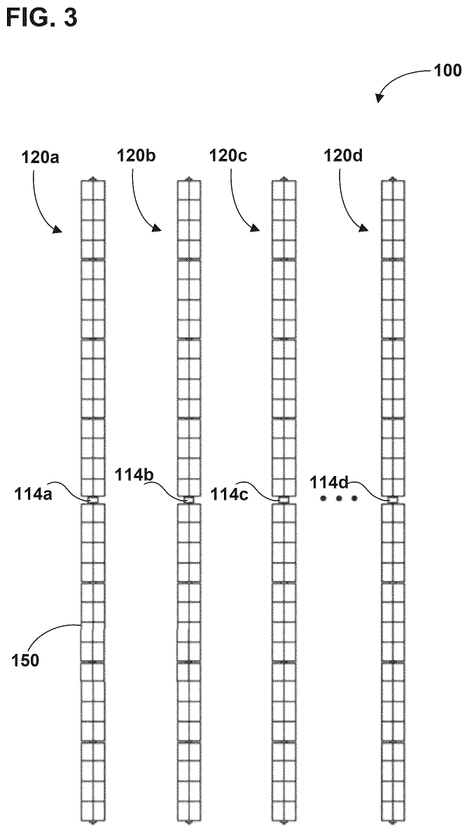

The solar tracker 10 may be a part of a larger solar tracker system that may include a plurality of solar trackers 10 arranged in rows. An example of a single solar tracker row 120 is depicted in FIG. 2A Each row of solar trackers 10 may be referred to as a solar tracker row 120. The solar tracker 10 has a number of bays 20 defined by the distance between adjacent piers or ground piers 18 (generally referred to herein as piers 18) as shown in FIGS. 2A and 2B. The solar tracker 10 may be a part of a larger solar tracker system 100 that may include a plurality of solar trackers 10 arranged in rows, an example of which is shown in FIG. 3, where each row of solar trackers may be referred to as a solar tracker row (e.g., solar tracker rows 120a, 120b, 120c, and 120d in FIG. 3). FIG. 2B illustrates two bays 20 of the solar tracker 10. However, it will be appreciated that the solar tracker 10 may include four bays, six bays, ten bays, twenty bays, or any other suitable number of bays as desired. At or near each pier 18, there is either a bearing 22 or, as shown in FIGS. 1-2B, a drive mechanism 16. The drive mechanism 16 shown in FIGS. 2A and 2B, for example, are disposed near the center of the solar tracker 10, although the location may vary. Each of the bearings 22 and the drive mechanism 16 are supported by a corresponding one of the piers 18. Activation of the drive mechanism 16 rotates a torque tube 14 about an axis of rotation and thus rotates one or more solar modules 12 mounted to the torque tube 14 such that the solar modules 12 can be oriented to a desired position. That desired position may be a position intended to capture maximum sunlight (e.g., to thereby generate maximum solar energy) based on the location of the sun in the sky. The desired position of the solar modules 12 may be a 0-angle position during times of diffuse sunlight, for example. The desired position of the solar modules 12 may be, in some circumstances, a safety position warranted by weather conditions such as high winds or a snow storm, or possibly an intermediate position (e.g., between a safe, 0-angle position and an optimal solar energy capture position), as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

With continued reference to FIGS. 1-2B, the torque tube 14 may be sized (e.g., diameter, wall thickness, material) such that sagging of the torque tube 14 between the piers 18 is reduced or substantially eliminated; the torque tube 14 may also be sized to absorb torsional loads applied to the torque tube 14 by wind loading (or loading by other external forces). In addition, since there is typically just a single drive mechanism 16 associated with a given solar tracker 10, the specifications for the torque tube 14 may also seek to reduce twist of the torque tube 14 along its length. Twisting typically results in the solar modules 12 of a given solar tracker 10 being oriented differently along the length of the solar tracker 10 from what is desired, and thus would tend to reduce the output and efficiency of the solar tracker 10, particularly, as the solar tracker 10 is rotated to the extreme angles of its angular range (e.g., +/−60 degrees or more).

As will be appreciated, the solar modules 12 must be supported on the torque tube 14. This is typically achieved by using a number of brackets (e.g., a bracket system) coupled to the torque tube 14 and oriented generally perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms, including shaped steel components, which may be arranged to sandwich the solar modules 12, and which may be configured to connect to a rail, which is then coupled to the torque tube 14, in some embodiments.

FIG. 3 is a top plan view of an exemplary solar tracker system 100 including a plurality of solar tracker rows, such as for example, a first solar tracker row 120a, a second solar tracker row 120b, a third solar tracker row 120c, and a fourth solar tracker row 120d (generally referred to herein as solar tracker rows 120). Although four solar trackers rows 120 are shown in FIG. 3, the number of solar tracker rows 120 making up a solar tracker system 100 may vary and could be more or less than that shown in FIG. 3. The solar tracker rows 120 may be arranged in parallel in a generally north-south direction, for example, as shown in FIG. 3. It will be appreciated that the phrase “north-south direction” may mean approximately north or approximately south, for instance, typically within a range of about 15 degrees of true north-south. In some cases, the solar tracker rows 120 may include interior solar tracker rows, such as for example, solar tracker rows 120b and 120c, and exterior solar tracker rows, such as for example, solar tracker rows 120a and 120d. It will be appreciated that interior solar tracker rows are typically considered to be solar tracker rows 120 positioned between two other solar tracker rows 120, and exterior solar tracker rows are typically considered to be solar tracker rows 120 with no solar tracker row 120 positioned on one side of the exterior solar tracker row. The solar tracker rows 120 may have a plurality of solar modules 150 arranged in a generally north-south longitudinal orientation to form the solar tracker rows 120. Each one of the plurality of solar modules 150 may be supported on a torque tube 114a, 114b, 114c, 114d (generally referred to herein as torque tubes 114), which in turn is supported by a plurality of support piers (not explicitly shown in FIG. 3). The solar tracker rows 120 depicted in FIG. 3 may be separated from one another by a space sufficient to allow movement of certain vehicles and/or machinery to allow for cleaning and maintenance.

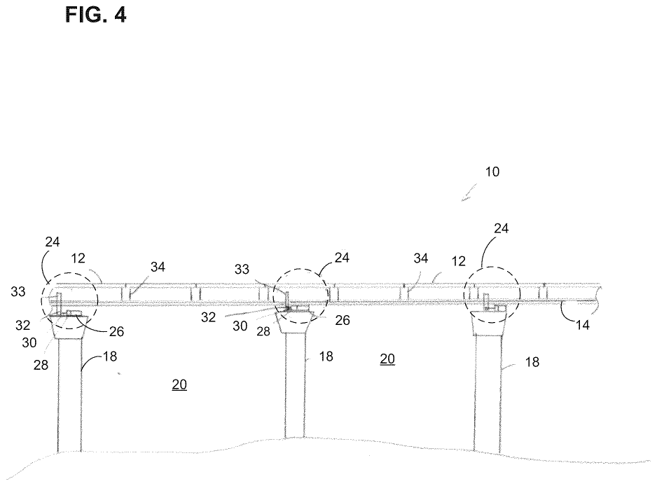

FIG. 4 is a schematic side view of a solar tracker 10 in accordance with this disclosure. In contrast with the solar tracker 10 depicted in FIGS. 1-3, rather than having a drive mechanism 16 mounted on a single pier 18 in the middle of the solar tracker 10, the solar tracker 10 of FIG. 4 includes a high efficiency drive mechanism 24 mounted on multiple piers 18 along the length of the solar tracker 10. Though depicted in FIG. 4 as including a high efficiency drive mechanism 24 on each pier, this disclosure is not so limited. Rather, the number of high efficiency drive mechanisms 24 may be determined based on the energy necessary to rotate the torque tube 14 and then divided by the energy output of an output rating of a desired size of high efficiency drive mechanism 24. The result will reveal the number of high efficiency drive mechanisms 24 that are required on the individual solar tracker 10. The result may be a distributed drive system where the drive of the solar tracker 10 may be distributed along its length. However, in some applications the result may yield just one high efficiency drive mechanism 24 per solar tracker 10 is necessary for certain application of this disclosure.

As depicted schematically in FIG. 4, each high efficiency drive mechanism 24 may include several components such as a motor 26, a high efficiency gear box 28, a shaft 30, and a driving gear 32 and a driven gear 33 that is coupled to and/or mounted on the torque tube 14. Though not shown in FIG. 4, the high efficiency gear box 28 may include a braking mechanism. As will be appreciated, because there are multiple high efficiency drive mechanisms 24, the size (e.g., the output rating) of the motor 26 can be greatly reduced as compared to the motor used for the worm drive mechanism 16 of FIG. 1. This reduction in output rating allows for the overall size of the motor 26, the gear box 28, the drive gear 32 and the driven gear 33 to also be reduced. As one benefit of this reduction in size, the size of the gaps between the solar modules 12 (e.g., the gaps on either side of each pier 18 of the solar tracker 10 depicted in FIG. 2B) can be greatly reduced or eliminated, thus increasing the number of solar modules 12 the solar tracker 10 may bear over a given length, and increasing the output of the solar tracker 10 for that given length. Another potential benefit is that the length of the solar tracker rows could be increased (e.g., made longer). Alternatively, in some embodiments, the motor 26 could be located at or near an end of the solar tracker 10, for example.

With reference again to FIG. 4, although driven gear 33 is shown circumscribing the torque tube 14, in some embodiments, driven gear 33 may only partially circumscribe torque tube 14, and may, for example, define an arc of between 135-195 degrees, or any suitable range of angular arcs. In some implementations, by reducing the angle of circumscription of the driven gear 33 about the torque tube 14 to 180 degrees or less, the height of supports 34 may be reduced.

In some embodiments, motor 26 may be a brushless direct current (DC) motor. In some instances, the DC motor may be without a hall effect sensor (e.g., a sensor-less motor). Further, while a reduction in the size of the motor 26 is one potential advantage of the solar tracker 10 of FIG. 4, it is by no means the only advantage. For example, by reducing the size of the motor 26, the cost of the high efficiency drive mechanism 24 may be greatly reduced. Similarly, with a reduction in the size of the motor 26, the size of the gear box 28, shaft 30, drive gear 32 and driven gear 33 may also be reduced in size, further reducing costs. In one example, the size of the motor 26 and gear box 28 is reduced. The motors for current worm gear drives employed on many existing solar trackers are rated at about 5 kNm of maximum torque; however, the normal driving torque is only about 1 kNm to 2 kNm when the solar tracker is not experiencing any wind loading. The current worm gear drives also are typically rated for about 30 kNm of non-driving or back holding torque. That is, the worm gear drive can withstand a high wind event loading the worm gear drive up to 28 kNm without allowing the solar tracker 10 to be back driven. In accordance with this disclosure, because the high efficiency drive mechanism 24 may be designed to permit back driving of the solar tracker 10, the high efficiency drive mechanism 24 need not be built to withstand the 28 kNm of non-driving torque, and the size of the motor 26 and gear box 28 may be reduced accordingly. Further, if multiple high efficiency drive mechanisms 24 are employed along the solar tracker 10, then the size of the motor 26 can be further reduced. For example, if two high efficiency drive mechanisms 24 are employed, then each motor 26 need only be rated to 2.5 kNm to achieve the desired operational torque ranges.

In some embodiments, motor 26 functions as a motor when power is supplied to it, but may also be configured to function as a generator and/or a brake when it is driven by external forces (e.g., the force of wind acting on the solar modules can change the angular orientation of the solar modules, which rotates the torque tube, which rotates the gear assembly and, in turn, the motor). This rotation of the motor generates an electrical energy or power signal (e.g., a measurable current or voltage) that can be measured, detected, or stored in an energy storage device for later usage. Rotation of the motor may also provide a braking force that may help to slow the speed at which back-driving of the motor occurs. This braking force may also function to help avoid overvoltage or overcurrent faults in the associated solar tracker controllers, for example.

Another benefit of distributing the drive mechanism along the solar tracker, as shown in the solar tracker 10 of FIG. 4, is that the gearing employed in the high efficiency gear box 28 introduces relatively little friction into the system. This is in stark contrast to the worm gear systems described above. The use of the high efficiency gear box 28 with gears having a relatively low incidence of friction between them allows the gears and the torque tube to which they are coupled to be driven with less energy. As noted above, one of the major factors in sizing a motor to drive the worm gear drive is the amount of energy needed to overcome the relatively high amounts of friction in the gearing that helped to prevent back driving of the solar tracker. Thus, by utilizing high efficiency gears, as described herein, there is less friction to overcome when seeking to drive the torque tube 14 of the solar tracker 10 to a desired orientation, thereby improving the overall operational efficiency of the solar tracker 10.

Current worm gear drive systems which have a gear ratio of typically between 40:1 and 50:1, employ, for example ACME threads at 5 turns per inch and are by design non-back drivable. The result is that such worm gear drive systems have a mechanical drive efficiency of 40% or less. This level of efficiency is a result of the constant sliding contact of the worm gear, connected to the motor, with the spur gear they typically drive. Such lower-efficiency gear drive systems have been employed in traditional systems specifically to resist or prevent back-driving.

In contrast, high efficiency gears typically achieve an efficiency of 90% or greater. The high efficiency gears, which may be one or more of planetary, helical, spur gears, bevel gears, face gears, spiral bevel gears, and other types of gears, are designed to minimize sliding contact, and are also therefore easily back-drivable.

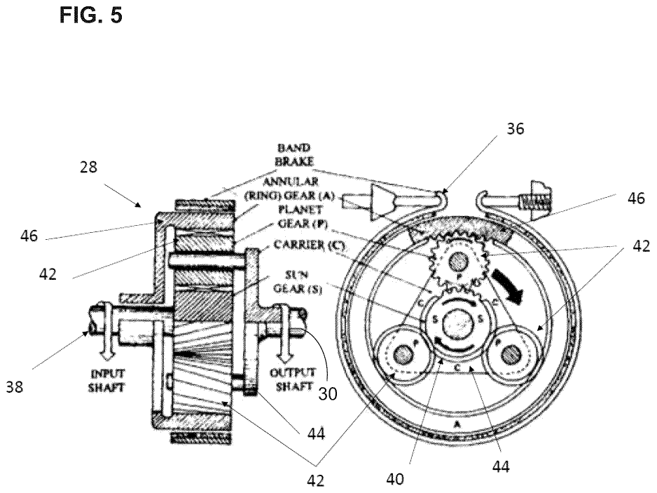

As will be readily appreciated, the use of high efficiency gear box 28 results in there being little resistance to back driving of the solar tracker 10 as described above. To prevent back driving a high efficiency gear box 28, a brake 36 such as band brake 36 shown in FIG. 5 may be employed. In one example of this disclosure, the motor 26 includes a shaft 38 which connects to, or couples to, the high efficiency gear box 28 employing a planetary gear arrangement as shown in FIG. 5. In the embodiment shown, shaft 38 interacts with a sun gear 40 mounted on an end of the shaft 38 opposite the motor 26. The sun gear 40 is surrounded by three planetary gears 42 mounted on a carrier 44. The planetary gears 42 rotate within a ring gear 46. An output shaft 30 (also shown in FIG. 4) mates with the drive gear 32 and interfaces with the driven gear 33 mounted on the torque tube 14. The result is that the rotation of the sun gear 40 is transferred through the planetary gears 42, ring gear 46, drive gear 32 and driven gear 33 such that despite the motor 26 spinning the shaft 38 and sun gear 40 at, for example, 1800 rotations per minute (RPM), the drive gear 32 rotates at a small fraction of that rate, such that the driven gear 33 moves at a relatively slow rate, enabling the solar tracker 10 to be moved to generally track the path of travel of the sun throughout the day. As an example, a gear reduction of between 36,000 to 1 and 30,000 to 1 may be appropriate in some instances. Though described in conjunction with the above complex gearing, simplified gearing mechanisms and geometry may be employed without departing from the scope of this disclosure.

In accordance with various embodiments of this disclosure, the worm gears used in prior systems may be replaced with other higher efficiency gears (e.g., planetary gears) to greatly improve the efficiency. Worm gear drive systems typically already employ a first planetary gear, which is used to reduce the speed of rotation of the worm gear. Thus, in accordance with this disclosure, the worm gear may be replaced with another stage of planetary gears. In accordance with aspects of this disclosure, motor 26 may rotate at about 3000 rpm. The first planetary gears, as currently employed (e.g., a four-stage planetary gear) has an output of about 5 rpm. By replacing the worm gear with a second planetary gear (e.g., a three-stage planetary gear), the output of the second stage may be at the torque tube drive speed (e.g., sufficient to achieve sun tracking). As noted above, this greatly increases the efficiency. As a result, a reduction of just 17,000:1 or 10,000:1 or even less may be possible. The final reduction is a balancing of the torque needs of the solar tracker, the ability to effectively move the solar tracker during day light hours, and the ability to move the solar tracker quickly (e.g., at a relatively high speed) when needed (e.g., to place a solar tracker in a stow position in advance of, or upon detection of, a storm, or high wind event, etc.).

Although described herein as replacing worm gear drive system with alternative gears, this disclosure is not so limited. Instead, the pitch of the worm gear may be altered to achieve a similar effect. As noted above, current worm gears employed in a solar tracker 10 have a pitch angle or helix angle of 5 or 6 degrees. This prevents back driving of the solar tracker, but at the price of efficiency as noted above. In addition to the options provided above, a worm gear may be employed in the high efficiency gear box 28, however, using a pitch or helix angle that is increased to around 30 to 40 degrees. This change in pitch or helix angle reduces the sliding friction of the worm gear, and thus may allow the solar tracker to be back driven, with an increase in efficiency from about 40% to about 70%. Accordingly, though not providing the highest efficiency solution, higher efficiency worm gears may be similarly employed in the high efficiency gear box 28, according to some implementations of this disclosure.

In accordance with one aspect of this disclosure, brake 36 may act on an outer surface of ring gear 46. This may provide a relatively larger surface area upon which to apply the brake 36. The brake 36 may be connected to an electro-mechanical actuator (not shown). Upon application of an electrical signal, the actuator advances releasing the brake. However, once the signal is removed the actuator returns to an unadvanced state, allowing the brake (for example, through spring force) to reapply pressure to the outer surface of the ring gear 46. In this manner, the fault position for the brake 36 (e.g., if there is no signal applied to the actuator) is applying a force resisting the rotation of the solar tracker 10 and the torque tube 14. This may provide a fail-safe environment for the solar tracker 10 and may prevent uncontrolled movements of the solar tracker 10 in the event of a power failure or signal loss. Further, the total holding capacity of all of the brakes 46 may be selected to be greater than the moment generated by the highest design wind speed for a given location. Though described herein as a band brake, the brakes 46 are not so limited and may be embodied in disc brakes, drum brakes, multiple plates with smooth, textured, serrated, or corrugated contact surfaces, etc.

The electro-mechanical release of the brakes 36 can be achieved by one or more of a cam action, a linkage, a solenoid, an electro-magnet, a stepper motor, or other similar actuation devices that can be driven by a relatively low voltage (e.g., 5V, 12V, 24V) to open the brake 36 and release them from actuation. Further, though shown herein with the brake 36 being applied to the ring gear 46, the instant disclosure is not so limited and the brake 36 may be applied to any stage of the motor shaft 38 and the high efficiency gear box 28 including the output shaft 30, and/or any of the intermediate gears 40, 42, and 46. Additionally, the brake 36 may be mounted directly on the torque tube 14 to prevent the rotation of the torque tube 14 separate from the motor 26 and the high efficiency driving mechanism 24.

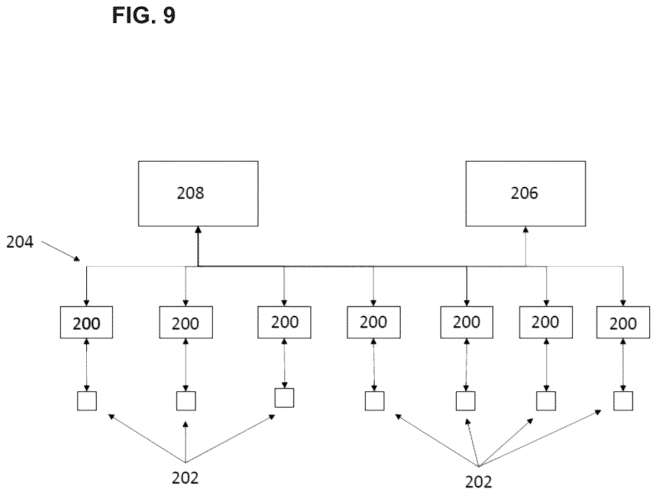

In a further aspect of this disclosure, a mechanical brake 36 may not be required. Rather, each motor 26, which includes permanent magnets on the rotor, may have its windings shorted (e.g., by a controller 200, as discussed below with reference to FIG. 9) at times where braking is desired. The shorted windings create a resistive holding torque (e.g., a magnetic braking force) that may slow or stop the rotation of the motor 26 and the solar tracker 10 mechanically coupled thereto. In accordance with this disclosure, the motor windings can be shorted to a known resistance to modulate the electromagnetic holding torque or resistance to driving by the interaction with the permanent magnets. The magnitude of the magnetic braking force, and therewith the permitted speed of rotation of the torque tube 14, can be adjusted by actively adjusting the winding resistance (e.g., engaging different levels of resistance to the windings). Those of ordinary skill in the art will recognize that an open circuit will result in zero braking effect.

In accordance with this disclosure, when weather conditions indicate that tracker 10 should move to a stow position, the power supplied to motor 26 may be interrupted. Thus, the solar tracker is no longer positively driven by motor 26. The solar tracker 10 is then allowed to rotate with the wind providing the motive force (i.e., back driven or forward driven) to reach the stow position. By shorting the windings of the motor 26 and adjusting the resistance of the drive circuit of motor 26, the permanent magnets of the motor brake the rotation of the solar tracker 10 to slow the rate of rotation and prevent damage to the solar tracker 10 as it approaches the mechanical stops of the solar tracker 10 in the stow position.

As will be appreciated, because the high efficiency drive mechanisms 24 are distributed along the length of the solar tracker, the amount of braking force that each brake 36 must apply to their respective ring gear 46 may be reduced to achieve the same braking force as achieved by the higher friction arrangements of traditional systems. This, reduction in force reduces point loads and distributes the driving and braking loads along the length of the torque tube 14. As will be appreciated, by distributing the loads, the potential for twisting of the torque tube during driving or braking is reduced. Thus, as noted above, the size of the motor 26 can be greatly reduced, but in addition, the dimensions of the torque tube 14 itself can be reduced. This may be a reduction in diameter, wall thickness, composition, or a combination of these and other factors.

In accordance with a further aspect of this disclosure, the motors 26 are sized such that failure of one or more of the brakes 36 along the length of the torque tube 14 can be overcome by the remaining high efficiency drive mechanisms 24, and particularly the motors 26. In this manner, the solar tracker 10 can continue operating as normal even if one of the brakes 36, motors 26, or high efficiency gear boxes 28 fail providing system redundancy and a robust platform for continued operation. Still further, operations for a solar tracker 10 need not be interrupted to service the component suffering the failure. Moreover, due to the reduced size of the motor 26 and high efficiency gear box 28, such maintenance becomes an easier task that can be manually performed without the need for a crane or other heavy lift mechanism as might be required if a drive mechanism 16 (e.g., a worm gear drive) is employed. The motors 26 can be selected with a rating sufficient to overcome 1, 2, 3, 4 or more simultaneous failures of high efficiency drive mechanisms 24 and continue operation. Each of the brakes 36 is configured such that the torque tube 14 can be driven or back driven by the remaining motors 26 without damaging brakes 36.

### Regenerative Braking

“Regenerative braking” is a term used to describe an energy recovery mechanism that can function to slow down a moving object (such as a vehicle) by converting its kinetic energy or potential energy into a form that can be either used immediately or stored until needed. Regenerative braking often involves an electric motor being caused to function as an electric generator and/or a brake. For example, in certain applications (e.g., electric or hybrid vehicles), the energy generated from regenerative braking may be stored chemically in a battery, or electrically in a bank of capacitors, or mechanically in a rotating flywheel. To cause an electric motor to function as an electric generator, the electric motor can be operated in reverse; that is, an external force may act upon a motor to cause it to rotate. When this occurs, the electric motor begins to function as an electric generator and will convert the mechanical energy supplied by the external force into electrical energy. Vehicles that are propelled by electric motors often use the same motors as generators when employing regenerative braking, which creates a braking force by transferring mechanical energy from the wheels to an electrical load, such as a battery. Delivering energy “backwards” through the system in this manner may enable the energy harvested from regenerative braking or deceleration to resupply an energy storage device such as a battery, or a capacitor, etc. This stored energy can then be later used to drive the electric motor in its normal “forward” direction, or to provide electrical power to other auxiliary components, etc.

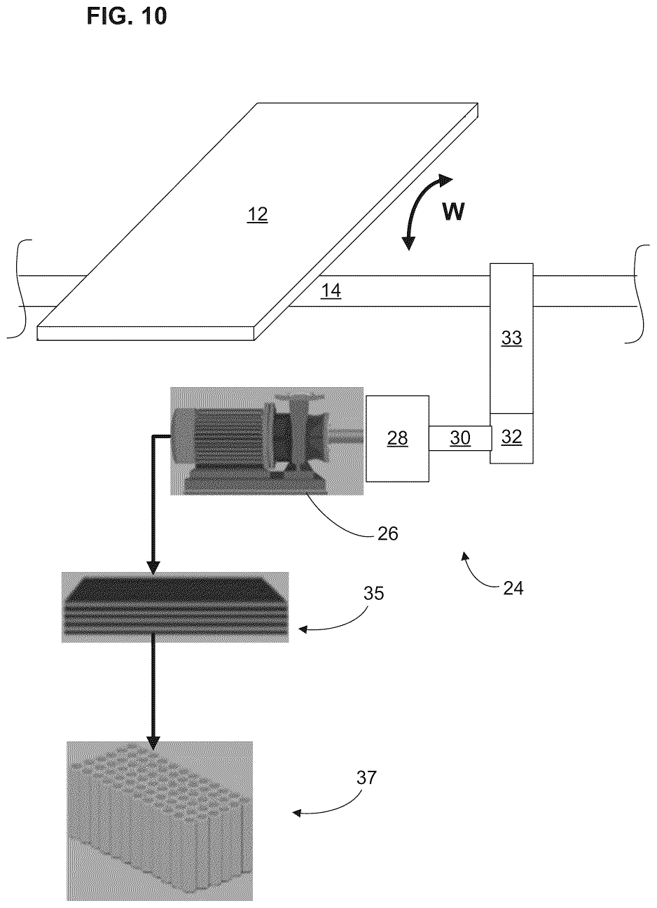

FIG. 10 is a schematic block diagram illustrating exemplary components of a system for employing regenerative braking in a solar tracking system. FIG. 10 shows a portion of a solar tracker system being exposed to an external force, “W,” such as a wind force. The force W acting upon one or more solar modules 12 of the solar tracker system may be sufficient to overcome frictional forces, for example, and may cause rotation of the solar modules 12 and the associated torque tube 14 (e.g., about the longitudinal axis of the torque tube 14). Rotation of the torque tube 14 may transfer all or a portion of the mechanical force W through the components of an efficient drive mechanism 24 (e.g., the efficient drive mechanism 24 may comprise a driven gear 33 coupled to and/or mounted on the torque tube 14, driving gear 32, shaft 30, high efficiency gear box 28, and motor 26, as illustrated in the example depicted in FIG. 10). Rotation of the shaft of the motor 26 caused by the external force W may result in the above-described “backwards” operation of the motor 26, which provides a braking force that resists such backward rotation, and which generates electrical energy in the form of a current and/or voltage (e.g., generated as an output at the terminals of the motor 26 that would normally receive electrical energy as in input to power the motor 26 during normal operation). The current/voltage generated by the motor 26 in this manner may be delivered to a power converter 35 in some embodiments, which may act to convert the electrical energy generated by the motor 26 to an appropriate electrical characteristic (e.g., to a DC voltage suitable for charging a battery 37, or to a different voltage level for driving an electrical load, as possible examples). As shown in the example of FIG. 10, the electrical energy (e.g., a DC voltage and/or current) that is output from the power converter 35 may be delivered to a battery 37 for storage (for later use to drive a load, for example). In some embodiments, the electrical energy stored by the battery 37 in this manner may subsequently be used to drive/actuate the motor 26 to turn the solar modules 12 of a solar tracker row to orient them in a manner appropriate for solar energy production. In some embodiments, the electrical energy generated by regenerative braking is relatively small, while the braking force provided by regenerative braking may function to protect the solar trackers and solar modules and may help avoid overvoltage or overcurrent faults in the associated solar tracker controllers, for example.

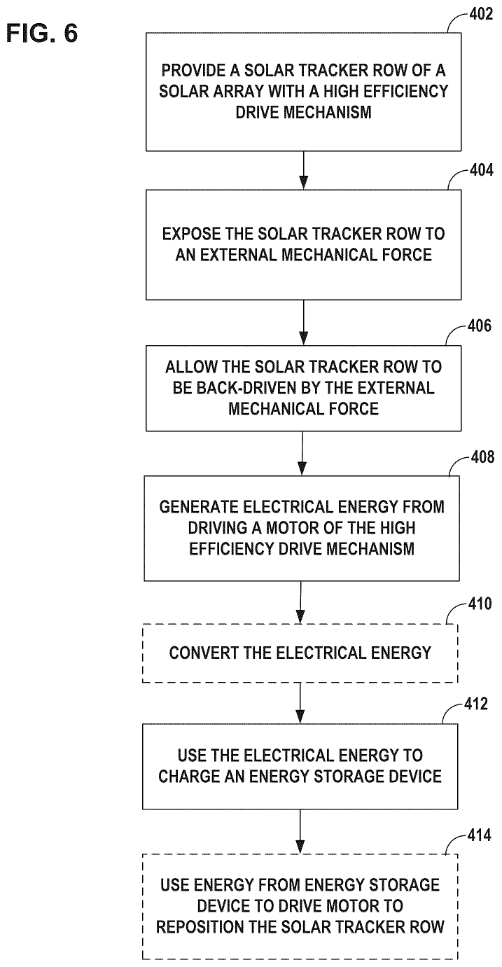

FIG. 6 is a flow diagram describing steps of an exemplary method of operating a solar tracker system to employ regenerative braking according to embodiments of this disclosure. In some embodiments, as shown at 402 in the method of FIG. 6, an initial step may be to provide a solar tracker row having an efficient drive mechanism (e.g., a high efficiency drive mechanism as described hereinabove). The efficient drive mechanism may, for example, comprise an efficient gear box including planetary gears, helical gears, spur gears, bevel gears, face gears, and spiral bevel gears. An efficient gear box typically may have an efficiency in the range of approximately 90%, according to some embodiments.

In some embodiments, as shown at 404 in the method of FIG. 6, a step may include exposing a solar tracker row to an external mechanical force. The external mechanical force may be provided by a variety of natural phenomena including wind, rain, or snow, as possible examples.

In some embodiments, as shown at 406 in the method of FIG. 6, a step may be to allow the solar tracker row to be back-driven by the external mechanical force. For example, step 406 may comprise allowing a strong wind force acting on one or more solar modules of a solar tracker row to move the solar modules, resulting in rotation of the solar modules and the associated torque tube. The use of an efficient drive mechanism with the affected solar tracker row may thereby result in the solar tracker row being back-driven; in such cases, a motor that is normally used to drive the torque tube and the associated solar modules to a desired angle for solar energy generation will be rotated in a direction “opposite” to that of its normal motor operating mode.

In some embodiments, as shown at 408 in the method of FIG. 6, a step may be to generate electrical energy from driving or turning a motor of the efficient drive mechanism. As noted above, the motor may be operated as an electrical generator when an external force is used to turn the shaft of a motor.

In some embodiments, as shown at 410 in the method of FIG. 6, an optional step is indicated (in dashed lines) whereby the electrical energy generated in an earlier step (e.g., step 408) may be converted or modified in some way. In some cases, this may be a matter of scaling the voltage up or down in magnitude to an appropriate level. In some cases, this may include an AC-to-DC conversion of electrical power in order to provide a DC electrical energy source suitable for charging an electrical energy storage device, such as a battery for example.

In some embodiments, as shown at 412 in the method of FIG. 6, a step may be to use the generated electrical energy to charge an energy storage device, such as a battery, or a capacitive storage device, for example.

In some embodiments, as shown at 414 in the method of FIG. 6, an optional step is indicated (in dashed lines) whereby the energy stored in the energy storage device is used to actuate/drive the motor of the high efficiency drive mechanism to position (or re-position) the solar tracker row (e.g., to resume solar energy production operations).

By employing the method of FIG. 6 to operate one or more rows of solar trackers, the back-driving of a solar tracker row (e.g., in response to an external force that is in excess of a threshold amount) may be employed as a way to generate electrical energy. Additionally, the generation of electrical energy may be used to charge a battery (or other comparable energy storage device). In such cases, the battery may act as a resistive load that provides a braking force to counter the external force, thereby slowing the rate of back-drive movement caused by the external force to a safe level (e.g., a level less likely to result in damage to the solar tracker row or the solar modules disposed thereon). Regenerative braking in this manner may also provide stored electrical energy that may be used to drive the motor to position the solar tracker row for improving solar energy production, according to some embodiments of this disclosure.

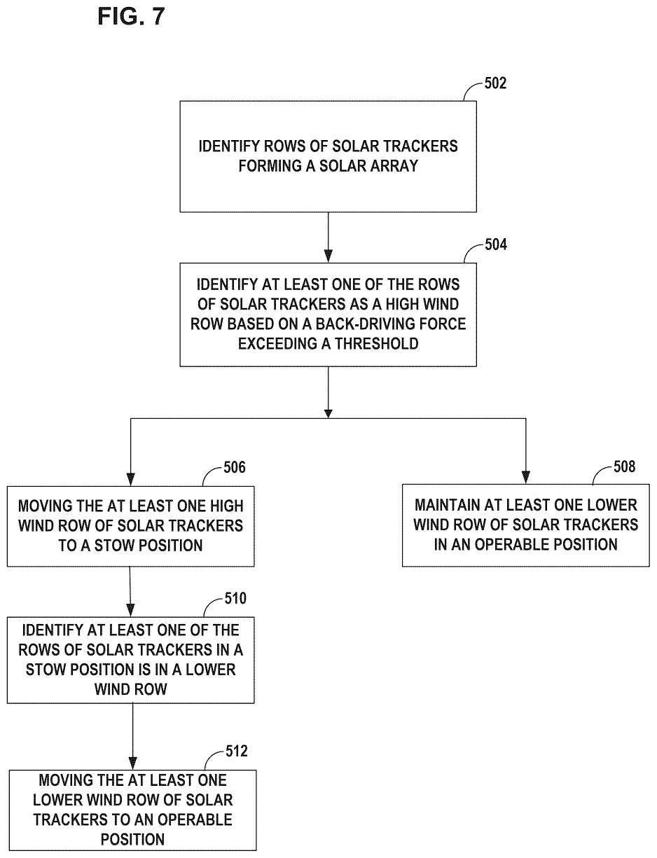

FIG. 7 is a flow diagram describing steps of a method of operating a solar array in accordance with some embodiments of this disclosure. At step 502, an initial step may be to identify rows of solar trackers that form the solar array. Referring back to FIG. 3, a number of solar tracker rows 120 may be arranged to make up a solar tracker system 100, for example. Four solar trackers rows 120a-120d are shown in FIG. 3, although the number of solar tracker rows 120 making up the solar array or solar tracker system 100 may vary and could be more or less than that shown in FIG. 3. The solar tracker rows 120 may be arranged generally parallel to each other, as shown in FIG. 3.

At step 504, a step may be to identify that at least one of the solar tracker rows 120 is a high wind row. In various embodiments of this disclosure, this may be done based on sensing or measuring a parameter related to the back-driving force being applied to a particular solar tracker row 120, and comparing the sensed/measured value to a threshold. If the sensed/measure value exceeds the threshold, the given solar tracker row 120 is deemed to be a high wind row. In some embodiments of this disclosure, for example, the sensed or measured parameter indicative of the back-driving force could be an amount of current generated by back-driving a motor 26 associated with a particular solar tracker row 120, for example. In such embodiments, if the back-driven current exceeds a threshold, the particular solar tracker row 120 is deemed to be a high wind row.

In some embodiments, it may be desirable to confirm that a high wind row is actually exposed to high winds (as opposed to receiving an erroneous reading, or a high reading caused by a force unrelated to wind, such as a downed tree pressing against a solar tracker, for example). In such an embodiment, an anemometer may be used as a back-up or confirmatory signal that could be checked to confirm that strong winds exist in the affected area before placing a given solar tracker row into a stow position.

At step 506, a step may be to move the high wind solar tracker rows identified in step 504 to a stow position. In some embodiments, moving a high wind solar tracker row to a stow position may involve allowing the solar tracker row to continue to be back-driven to a desired stow position; this may be optionally or additionally controlled by applying a current or voltage to the associated motor of the high wind solar tracker row to oppose and thereby slow the rate at which the row is back-driven to the appropriate stow position, for example. In other embodiments, the motor may be activated with a current or voltage sufficient to drive against and overcome the wind force to position the solar tracker row in an appropriate stow position.

At step 508, a step may be to maintain at least one solar tracker row (e.g., a lower wind row, where the sensed/measured value related to the back-driving force does not exceed the corresponding threshold) in an operable position for continuing to generate solar energy at the best position under the prevailing conditions (e.g., tracking the sun's position, accounting for cloud and diffuse light conditions, etc.). As shown in FIG. 7, step 508 may be performed concurrently with, or independently of, step 506. For example, if winds are light (or other external forces, such as snow, are minimal), step 508 would be performed (e.g., normal operations would continue) until such time that a high wind condition affects at least one solar tracker row causing step 506 to be performed.

At step 510, a step may be to identify that a solar tracker row that was previously identified as a high wind row and placed in a stow position as a result thereof, is now in a lower wind row (e.g., below the threshold) and therefore possibly ready to return to service. In some embodiments, this step may include waiting a predetermined period of time following placement into the stow position before evaluating whether the affected row has become a lower wind row. In other embodiments, weather data from external sources (e.g., forecast data feeds, local anemometer wind information, etc.) may be used as a confirmatory step (to double-check that strong wind conditions have actually abated) before placing a stowed solar tracker row back into normal operating positions.

At step 512, a step may be to move the lower wind solar tracker row to an operable position to thereby resume solar energy production at a desired level.

By employing the method of FIG. 7 to operate a solar array made up of a number of rows of solar trackers, one or more solar tracker rows that are determined to be in high wind rows (and therefore at risk of damage) are placed in a safe position (e.g., a stowed position) on an individual, selective basis, while maintaining the solar energy productivity of relatively unaffected (lower wind) solar tracker rows. The overall result is a net improvement in operational efficiency.

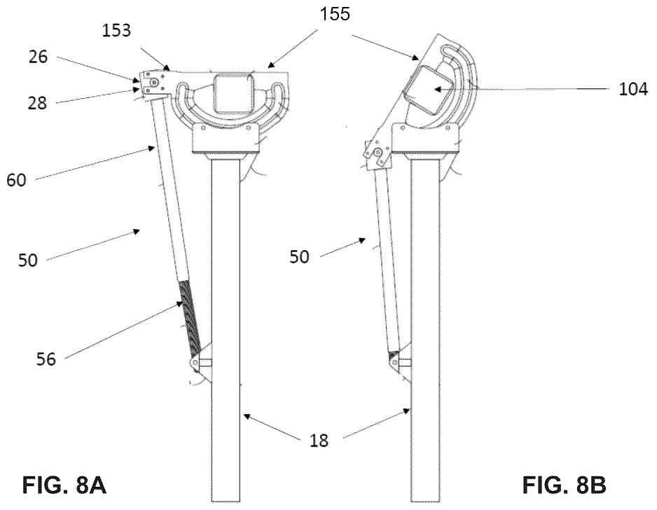

FIGS. 8A and 8B are side profile views showing an alternative arrangement employing a combination of a linear actuator 50 and a bearing assembly 155 associated with a pier 18. In the example of FIG. 8A, the bearing assembly 155 includes an arm 153 to which the linear actuator 50 is coupled at one end. Linear actuator 50 includes motor 26 and high efficiency gear box 28, which are rotatably coupled to the arm 153. Motor 26 and high efficiency gear box 28 drive the extension and retraction of a screw 56. For example, an output of the high efficiency gear box 28 connects to screw 56. A nut (not shown) is mounted on a sleeve 60, and one end of sleeve 60 is pivotally coupled to arm 153. The screw 56 threads into sleeve 60 (or into a nut of sleeve 60) and, when driven in a first direction, drives the screw 56 into the nut of sleeve 60 such that the total length of the linear actuator 50 decreases. When the screw 56 is driven in a second direction (opposite the first direction), the screw 56 is driven out of the nut of sleeve 60 such that the total length of the linear actuator 50 increases. The motor 26 and high efficiency gear box 28 are rotatably coupled to arm 153 enabling the rotation of the motor 26 and high efficiency gear box 28 observed by the comparison FIG. 8A and FIG. 8B as the screw 56 is retracted into sleeve 60, causing bearing assembly 155 to rotate to an extreme position (see FIG. 8B). As can be seen in FIG. 8A, an opening 104 formed in bearing assembly 155 may have a square shape, for example.

The use of multiple motors 26 and high efficiency gear boxes 28, each of which may operate in conjunction with a brake 36, enables the distributed and high-efficiency drive of solar tracker 10 in accordance with embodiments of this disclosure. This distributed drive may enable the use of multiple smaller motors 26 and multiple smaller high-efficiency gear boxes 28, reducing the friction as compared to centralized drive mechanisms. The use of multiple motors 26 may also be employed to overcome a failure of one or more of the motors 26, high efficiency gear boxes 28, or brakes 36, and may thereby enable continued normal operation, perhaps at increased power consumption to overcome the additional friction and resistance to motion from the failure and/or to prevent back driving of the solar tracker 10 by wind loading and other factors. Further, even if just a single high efficiency drive mechanism 24 is employed on the solar tracker 10, by allowing for back driving in high wind events (e.g., in excess of a given threshold based on the force of the wind, for example), the overall efficiency is still greatly increased due to the removal of high friction components currently utilized to withstand/resist wind loading and prevent back driving.

As will be appreciated, the distributed high efficiency drive solar tracker 10 described herein above is a mechanical structure that may be hundreds, even thousands, of feet in length. The use of multiple motors 26, high efficiency gear boxes 28, and brakes 36, however, may involve an additional level of coordination to ensure that the motors 26, the high efficiency gear boxes 28, and the electromechanical actuators used to release the brakes 36, are energized and actuated properly to avoid timing issues, etc. A further aspect of this disclosure is directed to a control architecture to achieve the desired level of coordination.

As depicted in FIG. 9, a further aspect of this disclosure is directed to a control architecture that includes a distributed motor controller 200 associated with, or located proximate, or even positioned on board with, each motor 26 of a solar tracker system. The distributed motor controller 200 may receive inputs from one or more sensors 202. A cable 204 connects the distributed motor controller 200 in communication with a master control unit 206. The cable 204 may also be configured to provide energy from a central power supply 208 to each of the motors 26 associated with a solar tracker 10. The cable 204 may be configured to carry control signals from the master control unit 206 to the distributed motor controller 200 and/or to the electromechanical actuator associated with the brake 36.

The sensors 202 may be configured to measure a variety of parameters associated with the operation of solar tracker 10. For example, sensors 202 may be configured to measure one or more of current or voltage of the motor 26, current or voltage of the electromechanical actuator for the brake 36, a position of the solar tracker 10 or of the brake 36, an amount of force applied by the motor 26, an amount of force applied by the brake 36, the torque applied by the motor, and/or other aspects of the high-efficiency drive. In some instances, sensors 202 may be position sensors, including one or more of displacement sensors, angular tilt sensors, single “home” sensors combined with a rotary encoder to count revolutions, and other types of sensors.

In some embodiments, sensors 202 and distributed motor controller 200 may operate to detect a force acting upon an individual solar tracker row 120 to an extent significant enough to warrant moving the affected solar tracker row 120 to a safety position or stow position. For example, a sensor 202 may be configured to sense or measure a parameter that can be used as a trigger signal to the associated motor controller 200 to initiate placing the affected solar tracker row 120 in an appropriate stow position. In some embodiments, the sensor 202 may measure an amount of current generated by back-driving the motor 26 due to the external force (e.g., a significant wind force); if the back-drive motor current generated exceeds a threshold amount, then the particular motor controller 200 causes the affected motor 26 to actuate to drive the solar tracker row 120 to a stow position. (In some cases, movement to the stow position may involve allowing the solar tracker row 120 to continue to be back-driven by the wind force, but employing the affected motor 26 to dampen or slow the movement to enable a more controlled movement of the solar tracker row 120 to the stow position, as appropriate.) As is contemplated herein, other types of signals from sensor 202 may serve as a viable trigger to initiate a stow operation in response to said signal exceeding some threshold criterion, for example. Other examples of measurable parameters from sensor 202 that could have an associated threshold for triggering stowing of a solar tracker may include: speed of rotation during back-driving, torque of the back-driving force, change in angular position, etc. In some cases, an amount of resistance may be provided (e.g., by the gears, possibly supplemented by a motor force) such that, any detected amount of back-driving would indicate that the threshold for triggering a stowing operation has been exceeded and accordingly, that stowing should commence.

In some embodiments, the current generated during back-driving of the motor 26 (e.g., due to an external force such as a significant wind force) may be utilized to charge a battery (not shown) that can later be used to drive the solar tracker row via the motor 26. In such an embodiment, the battery will act like a resistive load during such charging operations, which will also act to slow the rate at which the motor 26 is back-driven by the wind force, for example.

As will be appreciated, command signals from the master control unit 206 intended for each of the multiple motors 26 and the electromechanical actuators for the brakes 36 trigger switching at the distributed motor controllers 200 to enable the application of energy from the central power supply 208 to drive the motors 26 and the electromechanical actuators of the brakes 36. The coordinated release of the brakes 36 and the application of energy to the motors 26 enables the solar tracker 10 to be driven as needed to arrive at a desired position (e.g., based on position of the sun in the sky, diffuse light positions, wind stowage positions, and others). The sensors 202 feedback relevant data to the master control unit 206. The master control unit 206 employs a logic and can make determinations regarding the status, condition, position and other data related to solar tracker 10.

The central power supply 208 may be of a modular construction allowing it to be appropriately sized for the given solar tracker 10. As will be appreciated, a smaller solar tracker 10 will not require as large of a central power supply 208 as might a larger solar tracker 10, based on the number of motors 26 to be driven and the number of electromechanical actuators for the brakes 36 to be released. Further, the power cables 204 and their connectors may be standardized for compatibility and ease of installation.

In accordance with this disclosure, master control unit 206 may include a computer readable recording medium or may be connected to a cloud-based data storage system. One or more processors in the master control unit 206 may execute one or more applications stored in the computer readable recording medium. The one or more applications may provide a methodology for driving the high-efficiency drive systems described herein to move the solar tracker 10 to a desired position. These applications may have many inputs including the anticipated location of the sun at all times of the day. This may provide the baseline for the intended position to drive the solar tracker 10 throughout the day. The application may also be more complex and incorporate knowledge of the terrain, spacing of the solar trackers and other factors. Those of ordinary skill in the art will recognize that limiting shading, even where the solar tracker 10 no longer directly follows the sun will result in greater energy capture than allowing the solar modules 12 to become shaded by a neighboring solar tracker 10 or other near field obstructions. To achieve the desired movement of the solar tracker 10, the application may determine the current position of the solar tracker 10, determine an amount of desired movement, and then send control signals from the master control unit 206 to the distributed motor controllers 200. The distributed motor controllers 200 (one for each motor 26 and brake 36) can energize the motor 26 and the electromechanical actuator for the brake 36. A clock signal that is associated with the master control unit 206 and the distributed motor controllers 200 ensures that each of the motors 26 and brakes 36 of the given solar tracker 10 are energized at the same time to ensure smooth operation of the solar tracker 10.

A further aspect of this disclosure is directed to a solar tracker 10 and a high efficiency drive mechanism 24 that does not employ a mechanical brake. In such embodiments, the motor 26 is employed in combination with the high efficiency gear box 28 to control the orientation of the solar tracker 10. In times of external loading (e.g., wind loading, snow loading, etc.), the motor 26 may be controlled (e.g., via master control unit 206 and/or distributed controller 200) to control back driving of a solar tracker 10 or a solar tracker row 120 to a stow position. Rather than overcome the external loading force, the motor 26 can have its current and/or voltage adjusted such that the external loading force can still overcome the output of the motor 26, thereby allowing the external loading force to back drive the solar tracker 10. However, by continuing to energize the motor 26, the back driving of the solar tracker 10 can be controlled and the motor 26 acts as an electrical brake on the back driving of the solar tracker 10 (e.g., to slow the rate at which the solar tracker is back-driven). Depending on the magnitude of the loading (e.g., wind speed), the power (current or voltage) applied to the motor 26 to counter the external loading can be reduced to allow the torque tube 14 and the solar modules 12 mounted thereon to be back driven by the wind (or snow, etc.). The output of the motor 26 controls this back driving and allows the torque tube 14 and the solar modules 12 to be safely rotated by the external loading. As the external loading (e.g., wind) abates, the motor 26 may now overcome the effects of that loading and again drive the solar tracker 10 to its desired orientation for solar energy production (e.g., given the time of day, the location of the sun in the sky, cloud conditions, etc.).

In some embodiments, the current or voltage supplied to the motor 26 is not reduced but is essentially constant, and as the external loading increases, controlled back driving occurs without a change in operation of the motor 26. However, if the speed of rotation of the torque tube exceeds a threshold, the current or voltage applied to the motor 26 can be increased to increase the braking force applied to the torque tube 14, and to slow the back driving of the solar tracker 10. In some instances, the solar tracker 10 is allowed to be completely back driven to an end of travel location. However, in some wind conditions, it may be desirable for the solar tracker 10 to only be back driven to an interim position, for example, somewhere between the 0-degree (flat position) and the end of travel (substantially vertical) position.

Because the solar tracker 10 has solar modules 12, or portions of solar modules 12 on both sides of the torque tube 14, the wind loading, or other external loading applied to the solar modules 12 does not necessarily drive the solar tracker in just one direction. Rather, a portion of that loading seeks to rotate the torque tube in a first direction, and a second portion of that loading seeks to rotate the torque tube in a second opposite direction. Depending on the orientation of the torque tube 14 and the solar modules 12, external loading (e.g., high winds) can either rotate the solar modules 12 with the wind, or in some instances actually force the solar modules into the wind. In accordance with this disclosure, not only can the current or voltage applied to the motor 26 be adjusted in magnitude, the polarity of the current or voltage may also be changed (e.g., reversed). If, for example, the motor 26 is initially driving the solar tracker in a first direction and the external loading seeks to force the solar tracker 10 in that first direction, the polarity of the voltage applied to the motor 26 may be reversed to act to slow the movement of the solar tracker 10 and to counter the external loading.

In a further aspect of this disclosure, the master control unit 206 or the distributed controllers 200, can adjust the current or voltage applied to the motor 26 by considering the input from the sensors 202. The sensors 202 may be wind sensors providing local wind speed and direction information, but may also be current sensors detecting the current applied to the motors 26 (or in some cases, detecting an amount of current generated by back-driving the motor 26), position sensors providing an indication of the orientation of the solar tracker 10, or other sensors and combinations of these sensors without departing from the scope of this disclosure. The sensor outputs from the sensors 202 are feedback that can be analyzed by the master control unit 206 or the distributed controller 200 to adjust the current and/or voltage (e.g., magnitude and/or polarity) applied to the motor.

The highest wind loading is typically experienced by the solar trackers 10 that are on the ends (e.g., the outer edges) of the solar power plant. Thus, typically the solar trackers 10 on the ends (either the outer most or the first two or three solar trackers) can act as a wind fence for the interior solar trackers 10. Wind striking the solar modules 12 on the outer rows of solar trackers 10 in the solar power plant may be re-directed (e.g., forced vertically) by the angulation of the solar modules 12. This change in direction creates turbulence and reduces the impact of the wind loading on the interior rows of the solar trackers 10. In the context of the instant disclosure, the master control unit 206 or the distributed controllers 200 may thus enable different wind loading responses to individual solar trackers 10 based on wind loading conditions that are fairly specific to a given solar tracker 10, and/or based on their location within the solar power plant. As an example, while the windward-most row of solar trackers 10 (or the windward-most two or three rows of solar trackers 10) may be permitted to back drive, as described herein, to a stow position based on the windspeeds, because the effective wind speed experienced by an interior solar tracker 10 is reduced by the wind fencing effect of the windward solar trackers 10, the interior solar trackers 10 may continue following the sun in their normal course of operation (e.g., not be placed in a stow position), or in diffuse light conditions be placed in an orientation to maximize electrical production for the given light conditions. Accordingly, the overall production of the solar power plant can be increased despite the high wind speed conditions affecting the windward most solar tracker 10 or windward most 2 or 3 solar trackers by selectively stowing only those solar tracker rows that are determined to be more susceptible to damage from the wind.

Various non-limiting exemplary embodiments have been described. It will be appreciated that suitable alternatives are possible without departing from the scope of the examples described herein.

What is claimed is:

1. A method of operating a solar tracker row of a solar array, the method comprising:
providing the solar tracker row with an efficient drive mechanism, the efficient drive mechanism comprising an electric motor and an efficient gear box;
exposing the solar tracker row to an external mechanical force;
allowing the solar tracker row to be moved about an axis by the external mechanical force such that movement of the solar tracker row about the axis causes the electric motor to be back-driven via the efficient gear box;
generating electrical energy from back-driving the electric motor; and
charging an energy storage device with the generated electrical energy.

2. The method of claim 1 further comprising:
converting the generated electrical energy to a format suitable for charging the energy storage device.

3. The method of claim 2 wherein the electrical energy storage device comprises a battery or a capacitive storage device.

4. The method of claim 2 wherein the format suitable for charging the energy storage device comprises a direct current (“DC”) voltage.

5. The method of claim 1 further comprising:
actuating the electric motor of the efficient drive mechanism by providing electrical energy from the energy storage device to the electric motor to change an orientation of the solar tracker row.

6. A solar tracking system for a solar array, the solar tracking system comprising:
a plurality of solar tracker rows, at least one of the solar tracker rows including:
a plurality of support piers;
a torque tube extending along the solar tracker row rotatably supported on the plurality of support piers;
a plurality of solar modules coupled to the torque tube; and
an electric motor configured to cause the torque tube to rotate via an efficient gear assembly,
wherein the electric motor is further configured to function as a regenerative brake in response to being back-driven by an external mechanical force acting upon the plurality of solar modules.

7. The solar tracking system of claim 6, wherein the electric motor is further configured to generate electrical energy while being back-driven by the external mechanical force.

8. The solar tracking system of claim 7, further configured to charge an energy storage device with the electrical energy generated by the motor while being back-driven by the external mechanical force.

9. The solar tracking system of claim 8, wherein the energy storage device is a rechargeable battery.

10. The solar tracking system of claim 8, wherein the energy storage device is a capacitive storage device.

11. The solar tracking system of claim 8, further configured to deliver energy from the energy storage device to actuate the electric motor to cause the torque tube to rotate via the efficient gear assembly.

12. A method of operating a solar tracker row of a solar array, the method comprising:
providing the solar tracker row, the solar tracking row comprising:
a plurality of support piers;
a torque tube extending along the solar tracker row rotatably supported on the plurality of support piers;
a plurality of solar modules coupled to the torque tube; and
an electric motor configured to cause the torque tube to rotate about an axis via an efficient gear assembly,
exposing the solar tracker row to an external mechanical force;
providing an amount of power to energize the electric motor to provide a force to the torque tube to oppose the external mechanical force; and
allowing the solar tracker row to be moved about the axis by the external mechanical force overcoming the force of the electric motor such that the electric motor is back-driven and provides a braking force to the external mechanical force.

13. The method of claim 12, further comprising:
increasing the amount of power provided to energize the electric motor to increase the braking force and reduce a speed at which the electric motor is back-driven.

14. The method of claim 12, further comprising:
reducing the amount of power provided to energize the electric motor to decrease the braking force and increase a speed at which the electric motor is back-driven.

15. The method of claim 12, further comprising:
varying the amount of power provided to energize the electric motor to change the braking force to allow the torque tube and the plurality of solar modules to be safely rotated by the external mechanical force.

16. The method of claim 12, further comprising:
increasing the amount of power provided to energize the electric motor to increase the braking force to overcome the external mechanical force.

17. The method of claim 16, further comprising:
continuing to energize the electric motor to overcome the external mechanical force and move the plurality of solar modules to a stow position.

18. The method of claim 15, wherein the plurality of solar modules are safely rotated to a stow position by the external mechanical force overcoming the braking force of the electric motor.

19. The method of claim 15, wherein the plurality of solar modules are safely rotated to a stow position by the braking force of the electric motor overcoming the external mechanical force.
